(19) United States
(12) Patent Application Publication
(10) Pub. No.: US 2013/0147668 A1
(43) Pub. Date: Jun. 13, 2013

(54) SPEED ESTIMATION METHOD

(71) Applicants: Hsu-Yang KUNG, Pingtung (TW); Chi-Chun LO, Pingtung (TW); Chi-Hua CHEN, Pingtung (TW); Bon-Yeh LIN, Pingtung (TW); Chun-Hao LIN, Pingtung (TW); Yan-Si LIU, Pingtung (TW)

(72) Inventors: Hsu-Yang KUNG, Pingtung (TW); Chi-Chun LO, Pingtung (TW); Chi-Hua CHEN, Pingtung (TW); Bon-Yeh LIN, Pingtung (TW); Chun-Hao LIN, Pingtung (TW); Yan-Si LIU, Pingtung (TW)

(21) Appl. No.: 13/359,868

(22) Filed: Jan. 27, 2012

(30) Foreign Application Priority Data
Dec. 12, 2011 (TW) 100145766

(51) Int. Cl. G01S 3/02

(52) U.S. Cl. 342/461

(57) ABSTRACT

A speed estimation method including a reference value establishing step, an actual value establishing step, an approximate location calculating step, a weight location calculating step, a weight location determining step and a speed calculating step is disclosed. The reference value establishing step determines a plurality of training locations and establishes a reference signal strength set for each training location. The actual value establishing step establishes an actual signal strength set of a communication device at a time point. The approximate location calculating step calculates a plurality of signal strength differences according to the actual signal strength set and the reference signal strength set, and generates a plurality of approximate locations. The weight location calculating step calculates a weight location of the communication device. The weight location determining step determines whether two weight locations are obtained. The weight location determining step calculates a speed of the communication device.

### BACKGROUND OF THE INVENTION

1. Field of the Invention

The present invention generally relates to a speed estimation method and, more particularly, to a speed estimation method that estimates the speed of a vehicle based on the signal strength between a mobile phone and a plurality of base stations.

2. Description of the Related Art

Vehicle speed can reflect whether an area has a smooth traffic flow. To ensure a smooth traffic flow of a road, the responsible government organization should keep taps on traffic conditions on different sections of the road. In this way, sections with low traffic speed can be found, and proper flow control or route guiding mechanism can be used to improve the traffic conditions.

Conventionally, a plurality of speed detectors is provided to detect the traffic conditions. The speed detectors are usually set in a plurality of predetermined locations of the road to retrieve the vehicle speed information. The speeds of the vehicles can be determined through the retrieved vehicle speed information. However, the vehicle speed on some sections of the road cannot be detected if the speed detectors are not enough in quantity. To the contrary, if there are too many speed detectors provided, high costs required for setting and maintaining the speed detectors will be resulted, leading to a tradeoff between performance and costs.

Besides, traffic information can also be retrieved by detective vehicles equipped with Global Positioning System (GPS). The detective vehicles can obtain instant traffic information while traveling on the road. However, the traffic conditions on different sections of the road cannot be accurately presented if there is a shortage in detective vehicles or there are not enough time samples. To the contrary, the traffic will be jammed if there are too many detective vehicles traveling on the road, affecting the traffic conditions while detecting the traffic conditions.

### SUMMARY OF THE INVENTION

It is therefore the primary objective of this invention to provide a speed estimation method that can reduce the costs required for setting and maintaining speed detectors.

The invention discloses a speed estimation method comprising a reference value establishing step, an actual value establishing step, an approximate location calculating step, a weight location calculating step, a weight location determining step and a speed calculating step. The reference value establishing step determines a plurality of training locations and establishes a reference signal strength set for each of the training locations, wherein the reference signal strength set represents the signal strengths of a respective one of the training locations to a plurality of base stations. The actual value establishing step establishes an actual signal strength set of a communication device at a time point, wherein the actual signal strength set represents the signal strengths of the communication device to the base stations. The approximate location calculating step calculates a plurality of signal strength differences according to the actual signal strength set and the reference signal strength set, and sets those training locations with smaller signal strength difference as a plurality of approximate locations. The weight location calculating step calculates a weight location of the communication device according to the plurality of approximate locations. The weight location determining step determines whether two weight locations of the communication device at two continuous time points are obtained, wherein the actual value establishing step is performed if the determination is negative. The weight location determining step calculates a speed of the communication device based on the two weight locations at the two continuous time points if the determination of the weight location determining step is positive.

The plurality of signal strength differences is calculated based on the following formula:

$$dist ( R , {L}_{i} ) = \sqrt{{\sum }_{j = 1}^{n} {( {R}_{j} - {C}_{ij} )}^{2}} ,$$

wherein Rⱼ represents an actual signal strength of the communication device to a j^{th} one of the base stations, and Cᵢⱼ represents a reference signal strength of the communication device to a j^{th} one of the base stations when the communication device is at an i^{th} one of the training locations.

The weight location of the communication device is calculated based on the following formula:

$$loc ( R ) = \frac{{\sum }_{a = 1}^{k} [ \frac{dist ( R , {H}_{k} ) - dist ( R , {H}_{a} )}{dist ( R , {H}_{k} ) - dist ( R , {H}_{1} )} \times {H}_{a} ]}{{\sum }_{a = 1}^{k} \frac{dist ( R , {H}_{k} ) - dist ( R , {H}_{a} )}{dist ( R , {H}_{k} ) - dist ( R , {H}_{1} )}} ,$$

wherein Hₐ represents an a^{th} one of the approximate locations, and dist(R, Hₐ) represents the signal strength difference between an actual location of the communication device and the a^{th} one of the approximate locations.

The speed of the communication device is calculated based on the following formula:

$${v}_{1 , 2} = \frac{dist [ loc ( {R}_{1} ) , loc ( {R}_{2} ) ]}{[ {T}_{1} , {T}_{2} ]} ,$$

wherein T₁ represents a first time point, T₂ represents a second time point, loc(R₁) represents a first weight location and loc(R₂) represents a second weight location.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a system on which a speed estimation method is operated according to a preferred embodiment of the invention.

FIG. 2 shows a flowchart of the speed estimation method according to the embodiment of the invention.

FIG. 3 shows the system on which the speed estimation method is operated, with the system showing different signal strengths.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

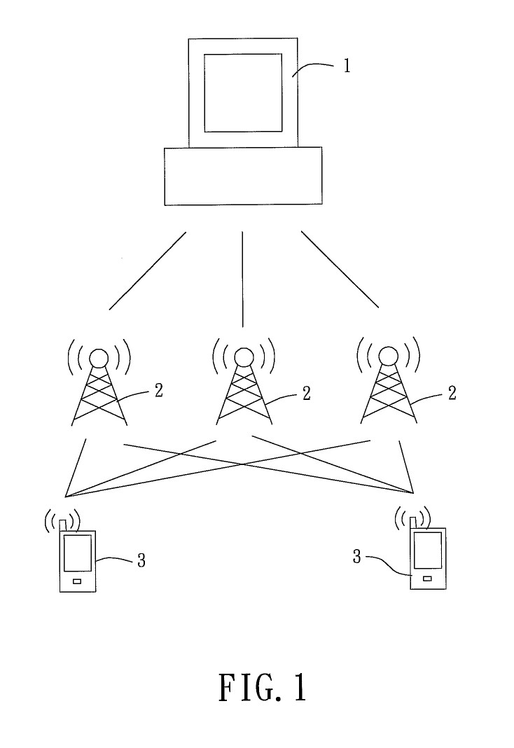

Referring to FIG. 1, a system using a speed estimation method is proposed according to a preferred embodiment of the invention. The system comprises a calculation device 1, a plurality of base stations 2 and a plurality of communication devices 3. The calculation device 1 may communicate with the plurality of base stations 2 to obtain a signal data therefrom. The calculation device 1 may be a computer capable of data registering and calculating. The communication devices 3 may exchange data with the base stations 2. Each communication device 3 is carried by a moving object, allowing the moving object to communicate with the base stations 2 through the communication device 3. In the preferred embodiment, the communication device 3 is a mobile phone and the moving object is a vehicle. However, the communication device 3 and the moving object are not limited thereto.

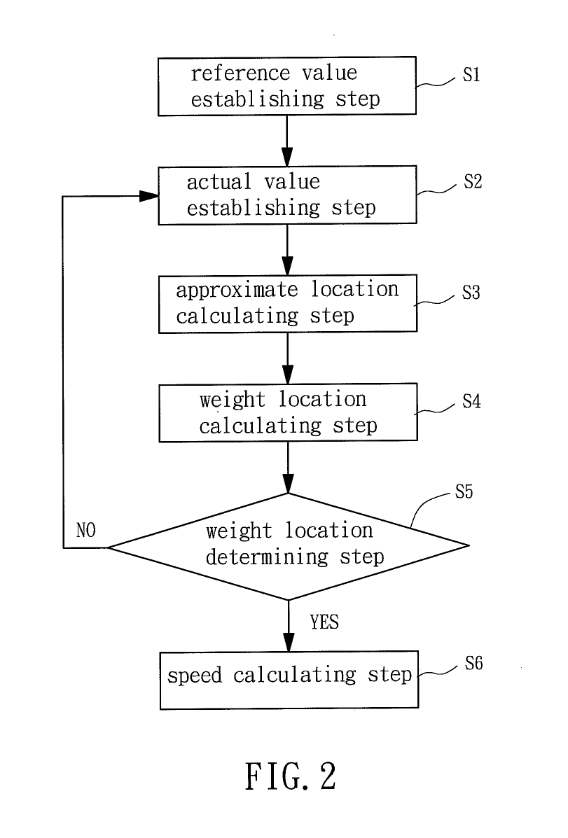

Referring to FIG. 2, the speed estimation method of the invention includes a reference value establishing step S1, an actual value establishing step S2, an approximate location calculating step S3, a weight location calculating step S4, a weight location determining step S5 and a speed calculating step S6.

The reference value establishing step S1 determines a plurality of training locations L and establishes a reference signal strength set C including a plurality of reference signal strengths:

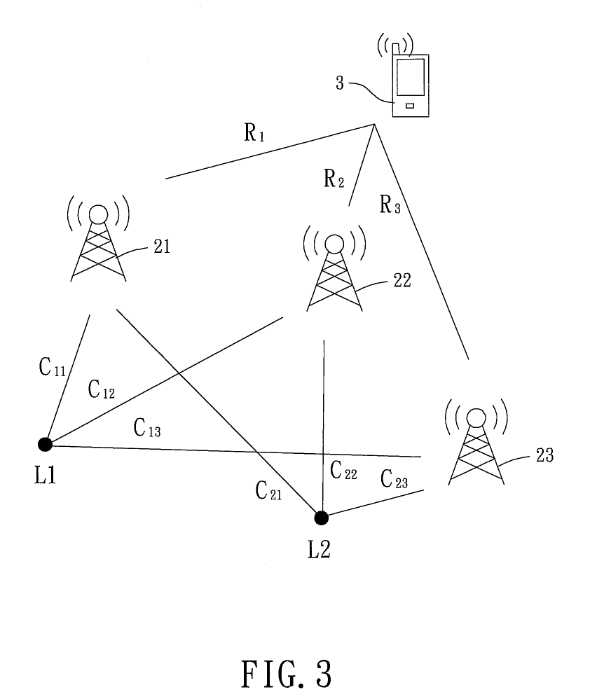

C=Cᵢⱼ,_{i=1, . . . ,m; j=1, . . . ,n}={C₁₁, . . . ,Cₘₙ}, (1)

wherein Cᵢⱼ represents a reference signal strength of the communication device 3 to a j^{th} base station 2 when the communication device 3 is at an i^{th} training location L. Specifically, the base stations 2 are located within an area encompassing all the training locations L. As shown in FIG. 3, the communication device 3 has a reference signal strength C₁₁ to the base station 21, a reference signal strength C₁₂ to the base station 22 and a reference signal strength C₁₃ to the base station 23 when the communication device 3 is at a training location L1. Therefore, the reference signal strength set C of the communication device 3 at the training location L1 may be represented by C₁ⱼ={C₁₁, C₁₂ C₁₃}. Similarly, the reference signal strength set C of the communication device 3 at the training location L2 may be represented by C₂ⱼ={C₂₁, C₂₂, C₂₃}. The reference signal strength sets C for all training locations may be stored in the calculation device 1 for further calculation.

The actual value establishing step S2 establishes an actual signal strength set R of the communication device 3 to the base stations 2 at a time point T. The actual signal strength set R may be presented as:

R=Rⱼ,_{j=1, . . . ,n}={R₁, . . . ,Rₙ}, (2)

wherein Rⱼ represents an actual signal strength of the communication device 3 to a j^{th} base station 2. Referring to FIG. 3 again, the communication device 3 has an actual signal strength R₁ to the base station 21, an actual signal strength R₂ to the base station 22, and an actual signal strength R₃ to the base station 23. Therefore, the actual signal strength set Rⱼ between the communication device 3 and individual base stations 2 may be represented by Rⱼ={R₁, R₂, R₃}. The actual signal strengths between the communication device 3 and individual base stations 2 may be provided to the calculation device 1 for further calculation.

The approximate location calculating step S3 uses the actual signal strength set R and the reference signal strength set C to calculate a plurality of signal strength differences (as the formula below), and sets those training locations L with smaller signal strength difference as a plurality of approximate locations H. In the embodiment, the formula for signal strength difference is presented below:

$$dist ( R , {L}_{i} ) = \sqrt{{\sum }_{j = 1}^{n} {( {R}_{j} - {C}_{ij} )}^{2}} . \qquad ( 3 )$$

Specifically, the plurality of signal strength differences having the same quantity as the training locations L may be obtained using the actual signal strength set R and the reference signal strength set C. Assume that the difference between the actual signal strength set R and the reference signal strength set C at a (i+1)^{th} training location L is small, the communication device 3 also has a small signal strength difference from the (i+1)^{th} training location L. This suggests that the (i+1)^{th} training location L is close to the communication device 3. To reduce the error in determining the distance between the communication device 3 and the training locations L, the training locations L with smaller signal strength difference are used as the plurality of approximate locations H for determining weight locations of the communication device 3. The quantity of the training locations L with smaller signal strength difference is not limited. In this embodiment, the quantity of the training locations L with smaller signal strength difference is k.

The weight location calculating step S4 calculates a weight location of the communication device 3 according to the plurality of approximate locations H, as shown in a formula below:

$$loc ( R ) = \frac{{\sum }_{a = 1}^{k} [ \frac{dist ( R , {H}_{k} ) - dist ( R , {H}_{a} )}{dist ( R , {H}_{k} ) - dist ( R , {H}_{1}} \times {H}_{a} ]}{{\sum }_{a = 1}^{k} \frac{dist ( R , {H}_{k} ) - dist ( R , {H}_{a} )}{dist ( R , {H}_{k} ) - dist ( R , {H}_{1} )}} , \qquad ( 4 )$$

wherein Hₐ represents an a^{th} approximate location H, and dist(R, Hₐ) represents the signal strength difference between the actual location of the communication device 3 and the a^{th} approximate location H (Hₐ). The weight location loc(R) of the communication device 3 may be determined based on the k approximate locations H, and the determined weight location loc(R) of the communication device 3 may be stored in the calculation device 1.

The weight location determining step S5 determines whether at least two weight locations loc(R) of the communication device 3 are obtained for two continuous time points. If not, the actual value establishing step S2 is performed again. The calculation device 1 obtains one weight location loc(R) of the communication device 3 for the time point T after the weight location calculating step S4. To calculate the speed of the communication device 3, two weight locations loc(R) of the communication device 3 at two continuous time points must be obtained. As such, the speed of the communication device 3 may be determined based on the time difference between the two continuous time points as well as the difference between the two weight locations loc(R). If only a single weight location loc(R) at a single time point T is available, then the actual value establishing step S2 is re-executed to calculate the weight location loc(R) for another time point T.

If the weight location determining step S5 determines that two weight locations loc(R) at two continuous time points are available, the speed calculating step S6 calculates the speed of the communication device 3 based on the two weight locations loc(R). In this embodiment, a first weight location loc(R₁) of the communication device 3 at a first time point T₁ and a second weight location loc(R₂) of the communication device 3 at a second time point T₂ may be obtained through the actual value establishing step S2 to the weight location calculating step S4. Then, the speed of the communication device 3 may be obtained based on a formula below:

$${v}_{1 , 2} = \frac{dist [ loc ( {R}_{1} ) , loc ( {R}_{2} ) ]}{[ {T}_{1} , {T}_{2} ]} . \qquad ( 4 )$$

Based on the above formula, the speed of the communication device 3 moving from the first time point T₁ to the second time point T₂ may be obtained. In the embodiment, the communication device 3 is carried by the vehicle for simultaneous movement. Thus, speed detection of the communication device 3 may be achieved through variations of signal strength of the communication device 3.

The speed estimation method of the invention is performed using the existing base stations and communication equipments without requiring arrangement of extra speed detectors, reducing the fees required for setting and maintaining the speed detectors.

The speed estimation method of the invention achieves the advantage of obtaining the needed vehicle speed information without requiring putting detective vehicles on the road.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A speed estimation method, comprising:
a reference value establishing step determining a plurality of training locations and establishing a reference signal strength set for each of the training locations, wherein the reference signal strength set represents the signal strengths of a respective one of the training locations to a plurality of base stations;
an actual value establishing step establishing an actual signal strength set of a communication device at a time point, wherein the actual signal strength set represents the signal strengths of the communication device to the base stations;
an approximate location calculating step calculating a plurality of signal strength differences according to the actual signal strength set and the reference signal strength set, and setting those training locations with smaller signal strength difference as a plurality of approximate locations;
a weight location calculating step calculating a weight location of the communication device according to the plurality of approximate locations:
a weight location determining step determining whether two weight locations of the communication device at two continuous time points are obtained, wherein the actual value establishing step is performed if the determination is negative; and
a speed calculating step calculating a speed of the communication device based on the two weight locations at the two continuous time points if the determination of the weight location determining step is positive.

2. The speed estimation method as claimed in claim 1, wherein the plurality of signal strength differences is calculated based on the following formula:
$$dist ( R , {L}_{i} ) = \sqrt{{\sum }_{j = 1}^{n} {( {R}_{j} - {C}_{ij} )}^{2}} ,$$
wherein Rⱼ represents an actual signal strength of the communication device to a j^{th} one of the base stations, and Cᵢⱼ represents a reference signal strength of the communication device to a j^{th} one of the base stations when the communication device is at an i^{th} one of the training locations.

3. The speed estimation method as claimed in claim 2, wherein the weight location of the communication device is calculated based on the following formula:
$$loc ( R ) = \frac{{\sum }_{a = 1}^{k} [ \frac{dist ( R , {H}_{k} ) - dist ( R , {H}_{a} )}{dist ( R , {H}_{k} ) - dist ( R , {H}_{1} )} \times {H}_{a} ]}{{\sum }_{a = 1}^{k} \frac{dist ( R , {H}_{k} ) - dist ( R , {H}_{a} )}{dist ( R , {H}_{k} ) - dist ( R , {H}_{1} )}} ,$$
wherein Hₐ represents an a^{th} one of the approximate locations, and dist(R, Hₐ) represents the signal strength difference between an actual location of the communication device and the a^{th} one of the approximate locations.

4. The speed estimation method as claimed in claim 3, wherein the speed of the communication device is calculated based on the following formula:
$${v}_{1 , 2} = \frac{dist [ loc ( {R}_{1} ) , loc ( {R}_{2} ) ]}{[ {T}_{1} , {T}_{2} ]} ,$$
wherein T₁ represents a first time point, T₂ represents a second time point, loc(R₁) represents a first weight location and loc(R₂) represents a second weight location.
